(19) United States
(12) Patent Application Publication
(10) Pub. No.: US 2009/0245988 A1
(43) Pub. Date: Oct. 1, 2009

(54) TRAILER AND PLATFORM UNIT

(76) Inventors: Andre BOUCHARD, Alma (CA); Mario Bergeron, Alma (CA)

Correspondence Address: OGILVY RENAULT LLP, 1, Place Ville Marie, SUITE 2500, MONTREAL, QC, H3B 1R1, CA

(21) Appl. No.: 12/055,715

(22) Filed: Mar. 26, 2008

(51) Int. Cl. B60P 1/04; F16F 1/00

(52) U.S. Cl. 414/469; 280/6.15; 267/64.11

(57) ABSTRACT

A trailer and platform unit of the type having a trailer defining a rear-end opening from the ground up through which an enclosure is accessed, with the platform adapted to support material and being loaded onto the trailer through the rear-end opening by the trailer backing into the platform whereby the platform engages and is supported by rails on opposed sides of the enclosure. The platform comprises a support surface to support material and lateral edge surfaces defining a periphery of the platform. Stabilizer devices each have a support arm with a first end connected to the platform, a second end projecting laterally away from one of the lateral edge surfaces of the platform, a base plate at the second end of the support arm. Adjustment mechanisms for each stabilizer device sets the vertical position of the base plate with respect to the platform so as to increase the footing of the platform on the ground.

### FIELD OF THE APPLICATION

The present application relates to trailer and platform units of the type featuring a U-shaped trailer supporting a platform with materials thereon, as most particularly used in the construction industry to leave the platform at a construction site with materials thereon.

### BACKGROUND OF THE ART

In large construction projects, numerous trailers, such as flat beds, repeatedly travel between the construction site and materials suppliers. Often, the trailers must be left at the construction site as the construction crew is not ready to use the building materials. Accordingly, numerous trailers are often required due to this waiting period at the construction site. Operators of trailer fleets must therefore maintain high numbers of trailers in operation to meet this artificial demand.

Trailer and platform combinations are an increasingly popular solution to reduce the costs of construction. The trailers typically consist of a U-shaped structure defining an enclosure from the ground up, with the enclosure being opened at the rear end of the trailer. In such systems, a trailer leaves a platform and its building material on site, while making other trips to carry other platforms. As a single trailer can be used with numerous platforms, a fleet operator can reduce the number of trailers used at a construction site.

One such trailer and platform combination is described as the Prefamax trailer system at www.faymonville.com. As an example, the trailer and platform combination is used to carry heavy building materials, such as concrete panels (e.g., prefabricated concrete panels), glass panels, windows, frames, etc.

However, it must be ensured that trailer and platform combinations safely lead the building materials to the construction site. Trailer and platform combinations should remain easy to use, despite the conditions found on construction sites, such as uneven ground, unpaved access, etc.

### SUMMARY OF THE APPLICATION

It is therefore an aim of the present application to provide a novel trailer and platform unit that addresses issues associated with the prior art.

Therefore, in accordance with the present application, there is provided a trailer and platform unit of the type having a trailer defining a rear-end opening from the ground up through which an enclosure is accessed, with the platform adapted to support material and being loaded onto the trailer through the rear-end opening by the trailer backing into the platform whereby the platform engages and is supported by rails on opposed sides of the enclosure, the platform comprising: a support surface adapted to support material and lateral edge surfaces defining a periphery of the platform; and at least one stabilizer device having a support arm with a first end connected to the platform, a second end projecting laterally away from one of the lateral edge surfaces of the platform, a base plate at the second end of the support arm, and an adjustment mechanism to set the vertical position of the base plate with respect to the platform so as to increase the footing of the platform on the ground.

Further in accordance with the present application, there is provided a trailer and platform unit of the type having a rear end of the trailer separated into left and right side portions, with an enclosure being defined from the ground up between the side portions, the enclosure being accessed through a rear-end opening of the trailer, with the platform being adapted to support material and being loaded onto the trailer through the rear-end opening by the trailer backing into the platform whereby the platform engages and is supported by rails within the enclosure and on each of the side portions, the trailer having a width-adjustment mechanism comprising: an actuator adjacent to the rear-end opening in one of the side portions, the actuator having an actuator arm displaceable along a width of the trailer as a function of actuation of the actuator; and a connection bar releasably connected at a first end to the actuator arm and at a second end to the other one of the side portions; whereby the actuator is actuated to adjust a width between the rails of the side portions of the trailer as a function of the width of the platform to be supported by the rails.

Still further in accordance with the present application, there is provided a trailer and platform unit of the type having a rear end of the trailer separated into left and right side portions, with an enclosure being defined from the ground up between the side portions, the enclosure being accessed through a rear-end opening of the trailer, with the platform being adapted to support material and being loaded onto the trailer through the rear-end opening by the trailer backing into the platform whereby the platform engages and is supported by rails within the enclosure and on each of the side portions, the trailer comprising a first wheel system on the left side portion of the trailer, and a second wheel system on the right side portion of the trailers each of the wheel systems having wheels supporting the trailer to the ground, and a height-adjustment mechanism so as to adjust a height of the trailer with respect to the ground, the height-adjustment mechanisms of the first and second wheel systems being independent from one another so as to independently adjust the heights of the left side portion and of the right side portion of the trailer, whereby a plane of the rails is leveled with the platform by actuation of at least one of the height-adjustment mechanisms prior to loading the platform on the trailer.

### BRIEF DESCRIPTION OF THE DRAWINGS

FIG. 1 is a perspective view of a trailer and platform unit in accordance with an embodiment of the present application, with the platform being loaded onto the trailer;

FIG. 2 is rear view of the trailer and platform unit of FIG. 1, with the platform gated in the trailer;

FIG. 3 is an enlarged perspective view of a width-adjustment mechanism on a left side portion of the trailer of FIG. 1;

FIG. 4 is an enlarged perspective view of the width-adjustment mechanism on a right side portion of the trailer of FIG. 1;

FIG. 5 is an enlarged view of a casing in a gate of the trailer of FIG. 1;

FIG. 6 is a perspective view of the platform of FIG. 1 supporting concrete blocks;

FIG. 7 a side view of a stabilizer used with the platform of FIG. 6;

FIG. 8 is an enlarged view of the stabilizer of FIG. 7 as connected to the platform;

FIG. 9 is a rear-end view of the trailer as tilted by height-adjustment mechanisms of the trailer; and

FIG. 10 is a block diagram view of the height-adjustment mechanisms in accordance with one embodiment of the present application.

### DESCRIPTION OF THE PREFERRED EMBODIMENTS

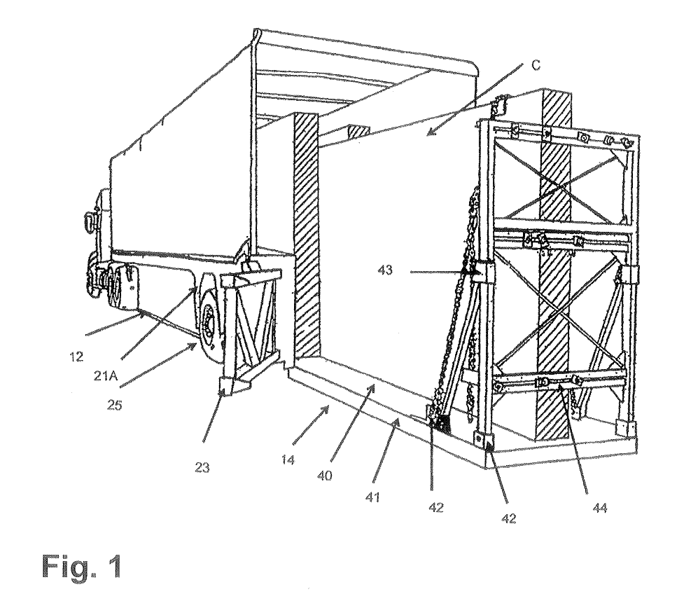

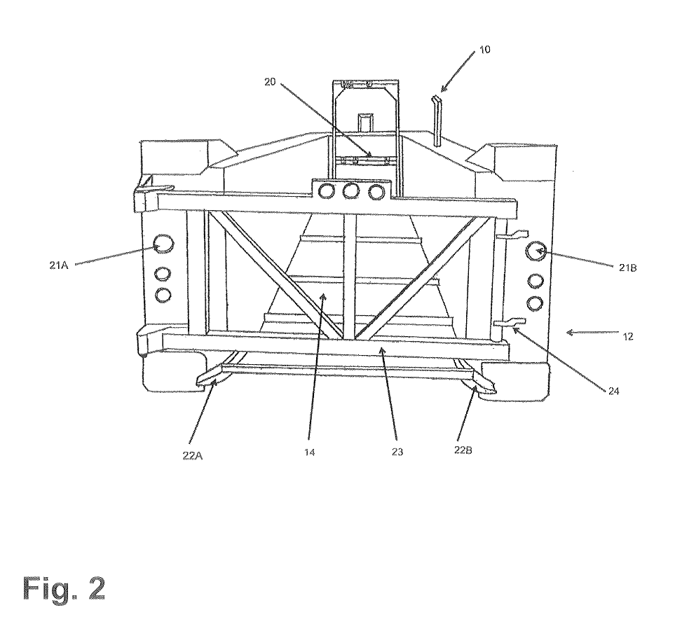

Referring to the drawings and more particularly to FIGS. 1 and 2, a trailer and platform unit in accordance with the present application is generally shown at 10, and has a trailer 12 and a platform 14.

The trailer 12 is of the type that is towed by a tractor, or may be in other embodiments an integral part of the truck. The platform 14 is of the type used to support materials, such as building materials of any kind (e.g., concrete panels, glass panels, windows, frames, etc). For illustrative purposes, the trailer and platform unit 10 is non-restrictively shown supporting concrete panels in some figures, but may be used with a variety of building materials. In a preferred use, the platform 14 is left on a construction site with the building materials it supports.

The trailer 12 is illustrated as defining a generally horizontal U shape, with a front portion 20, and side portions 21A and 21B, with affixed letter A representing the left side of the trailer 12 in the drawings and the affixed letter B representing the right side of the trailer 12 in the drawings. The front portion 20 is of the type that is connected to a tractor or like type of truck, and therefore an appropriate connection system such as a kingpin for a fifth wheel. The interconnection between trailer and truck is well known in the art and is not described in detail.

The front portion 20 and the side portions 21A and 21B define an enclosure in which the platform 14 and the building materials it supports will be received, as is illustrated in FIG. 2. Therefore, the side portions 21A and 21B respectively have support rails 22A and 22B within the enclosure. The support rails 22A and 22B support the sides of the platform 14.

Referring to FIGS. 1 and 2, a gate 23 is provided at a rear end of the trailer 12 so as to close the access to the enclosure. A connection system 24 locks the gate 23 in the closed position illustrated in FIG. 2.

The platform 14, with or without building materials, is loaded onto the trailer 12 by the trailer 12 backing into engagement with the platform 14. Therefore, the height of the trailer 12 with respect to the ground must be adjusted in order to allow engagement/disengagement of the trailer 12 with the platform 14. Referring to FIG. 1, a wheel system of the trailer 12 is illustrated at 25. The wheel system 25 includes the wheels, as well as an independent height-adjustment mechanisms between the wheels and the remainder of the trailer 12. The height-adjustment mechanisms are actuated in order to adjust the height between the ground and the trailer 12. The height-adjustment mechanisms on the side portions 21A and 21B are independent from one another.

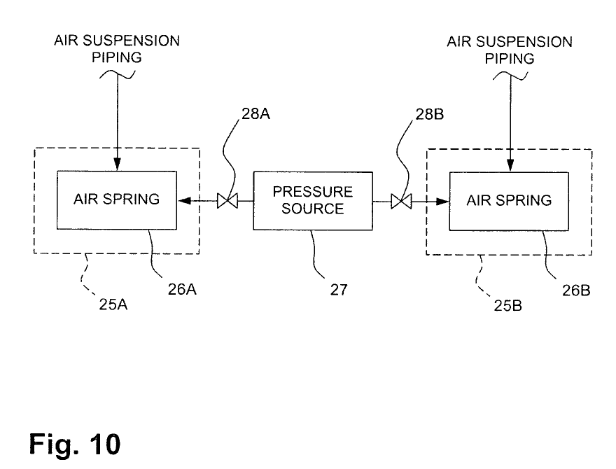

Referring to FIG. 10, one embodiment of the height-adjustment mechanisms is illustrated. The height-adjustment mechanisms use the air suspension of the trailer 12 to adjust independently the height of the left and right sides of the trailer 12. The height-adjustment mechanisms for the left and right side each use the air spring 26 of the wheel system 25. The air springs 26 are shown being in fluid connection with the air suspension piping, for the usual operation of the air suspension. For height-adjustment in specific loading conditions, the air springs 26 are fluidly connected to a pressure source 27, with valves 28 actuatable to manually pressurize the air springs 26 independently from one another.

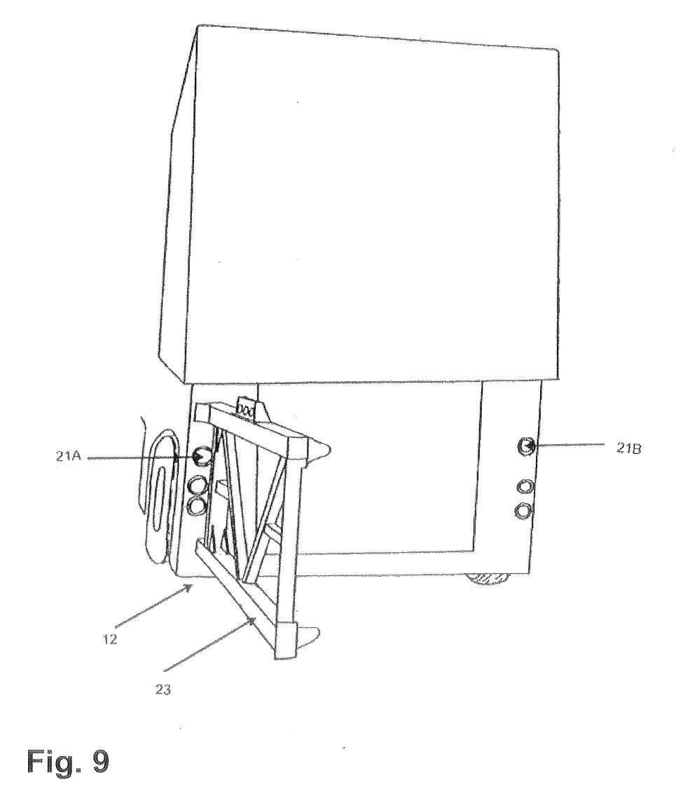

Therefore, as the trailer 12 has an independent control of height for both its left and right side portions 21, the trailer 12 may be tilted in order to get aligned with a platform 14. In FIG. 9, there is illustrated an actuation of the height-adjustment mechanisms, resulting in the trailer 12 being tilted. This feature is particularly useful, for instance to level the trailer 12 with a platform 14 that is on uneven terrain. More specifically, the plane of the rails 22 must be leveled with the platform 14, such that lateral side edges of the platform 14 engage with the rails 22 when the trailer 12 backs into the platform 14.

When the platform 14 is loaded onto the trailer 12 as illustrated in FIG. 2, the height-adjustment mechanisms are actuated to adjust the wheel systems 25 to road conditions, i.e., for the trailer 12 to carry the loaded platform 14 during transit. The height-adjustment mechanisms illustrated in FIG. 10 advantageously use some of the components of the suspension of the trailer 12. However, height-adjustment mechanism separate from the suspension may be used as well. The height-adjustment mechanisms are typically mechanical, hydraulic or pneumatic systems actuated independently, and sized so as to withstand the weight of a loaded platform with heavy building materials, such as concrete panels.

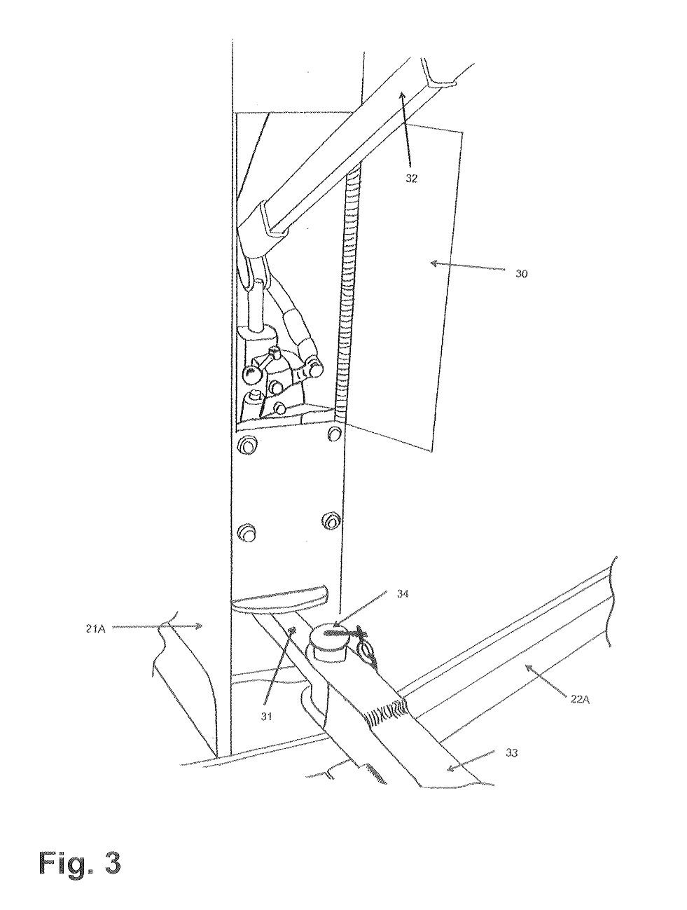

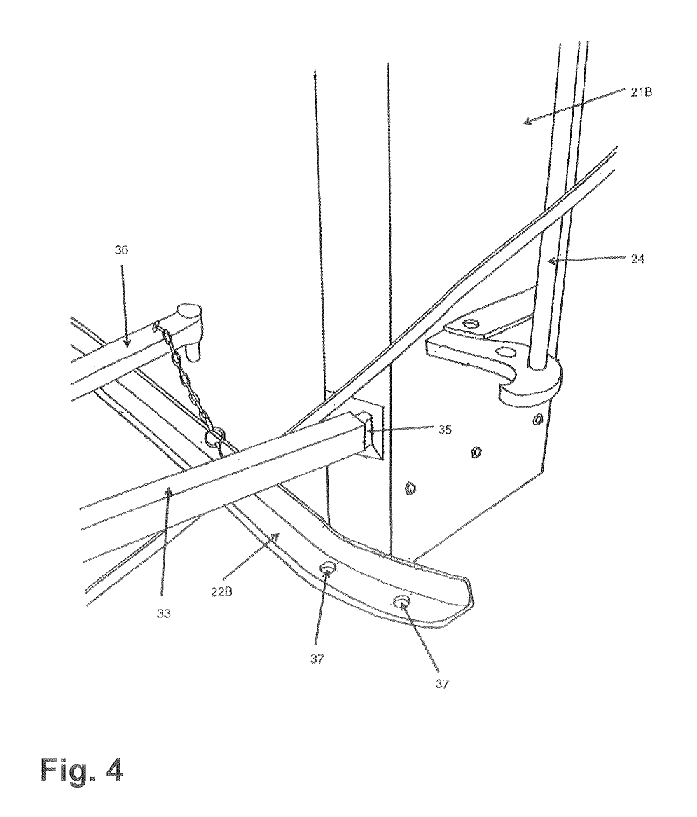

Referring concurrently to FIGS. 3 and 4, a width-adjustment mechanism is generally shown at 30. The width-adjustment mechanism 30 is provided to adjust the width between the left-side rails 22A and the right-side rails 22B in view of the rails 22 supporting the platform 14. More specifically, considering the U shape of the trailer 12, it is expected that the width varies between the rear ends of the side portions 21A and 21B. In order to facilitate the loading of the platform 14 on the trailer 12, the width between the side portions 21A and 21B is adjustable.

The width-adjustment mechanism 30 is partially accommodated in the left side portion 21A of the trailer 12, and has an actuator with an actuator arm 31. An actuation of the actuator results in displacement of the actuator arm 31 along the width of the trailer 12. In an embodiment, the actuator is actuated manually, whereby a lever 32 is provided to actuate the displacement of the arm 31. The actuator is any suitable mechanical actuator, such as a hydraulic cylinder.

As is illustrated in FIG. 3, a connection bar 33 is connected at a first end to the actuator arm 31. A pin 34 releasably interconnects the connection bar 33 to the actuator arm 31. As is illustrated in FIG. 4, a second end of the connection bar 33 forms a pivot housing 35. The pivot housing 34 is releasably connected to a pivot built into the right side portion 21B of the trailer 12.

When the connection bar 33 is connected at opposed ends to the actuator arm 31 and to the pivot, the actuator is actuated, for instance to bring the left and right side portions 21 toward one another. As a result, the width between the rails 22 is reduced. When the width between the rails 22 is generally equal to the width of the platform 14, the trailer 12 may be backed into the platform 14, whereby the platform 14 engages the rails 22 of the trailer 12. The connection bar 33 is removed beforehand.

Referring to FIG. 4, a fixing bar 36 is provided to interconnect the rails 22. More specifically, the fixing bar 36 has pins at its opposed ends, which pins are received in holes 37 in the rails 22. The bar 36 ensures that the width between the rails 22 is fixed once the trailer 12 is loaded with the platform 14, despite the pressure of the load on the rails 22 and the effects of the rolling condition of the trailer 12 on the load.

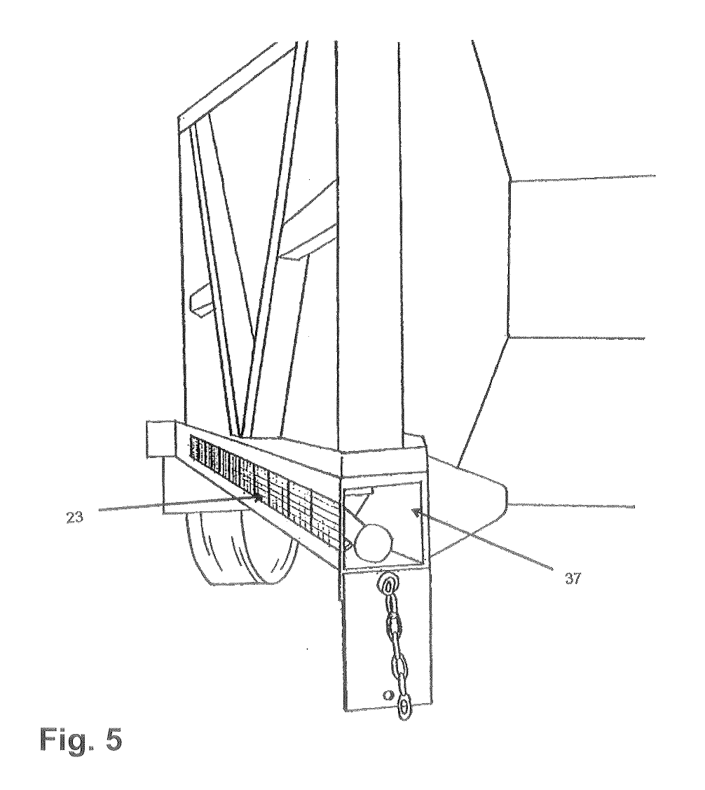

In order to simplify the width adjustment of the trailer 12, it is considered to provide the actuator of the mechanism 30 with a set position of the actuator arm 31. This set position corresponds to a width between the rails 22 in accordance with the width of the platform 14. Referring to FIG. 5, the gate 23 is shown having a casing 37, so as to accommodate the connection bar 33 and/or the fixing bar 36 when not being used.

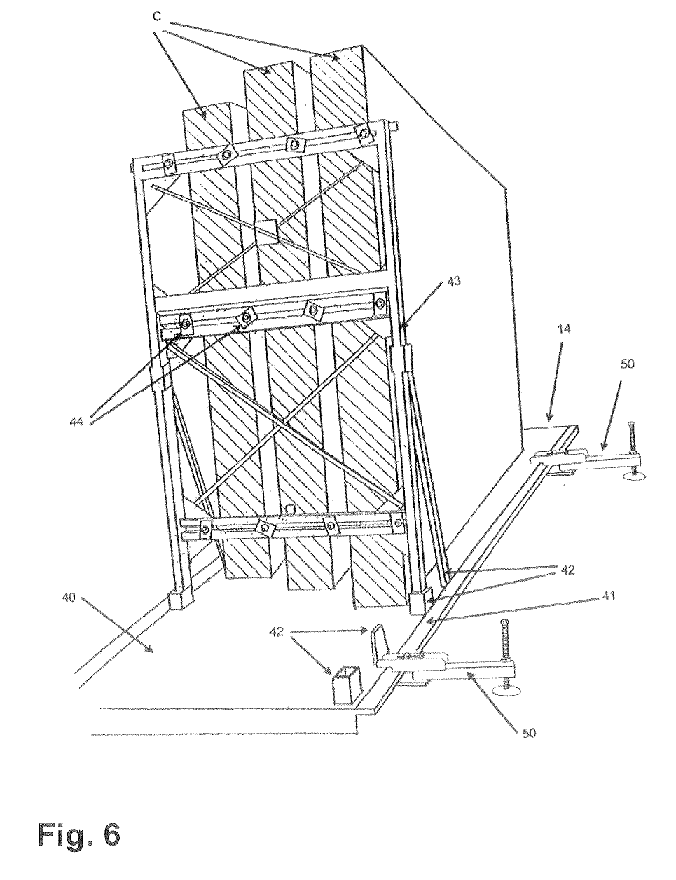

The platform 14 must often be unloaded on uneven terrain or on unstable soil (e.g., sand, gravel), as the platform 14 is commonly used on construction sites. As is shown in FIG. 6, the platform 14 must support heavy loads, such as the concrete blocks C. As the concrete blocks have a non-negligible height with respect to the width of the platform 14, the center of mass of the loaded platform 14 is above the ground. Therefore, when the loaded platform 14 rests on uneven terrain or unstable soil, there is a risk that the platform may tip over. Moreover, the blocks C are often removed one by one by a crane. The removal of the blocks C potentially shifts the center of mass laterally, thereby enhancing the risk that the platform may tip over. Accordingly, it is desired to increase the footing of the platform 14.

Referring to FIG. 6, the platform 14 has a support surface 40 upon which are positioned the concrete blocks C. The support surface 40 is peripherally delimited by the lateral edge surfaces 41. Supports 42 are provided on the support surface 40 adjacent to the lateral edge surfaces 41. The supports 42 are tubular housings accommodating post ends of racks, such as the rack 43.

As is illustrated in FIG. 6, the rack 43 forms vertical structures that holds the concrete blocks C in an upright position. The rack 43 has spacers 44 whose horizontal positions are adjustable as a function of the width of the blocks C. Although FIG. 6 illustrates an embodiment of the rack well suited to be used with concrete blocks, the racks may have different configurations as a function of the type of building material that will be supported by the platform 14.

Referring concurrently to FIGS. 6 to 8, the lateral edge surfaces 41 define a flange 45. Stabilizers 50 are connected to the platform 14, and more specifically to the flange 14, so as to increase the footing of the platform 14.

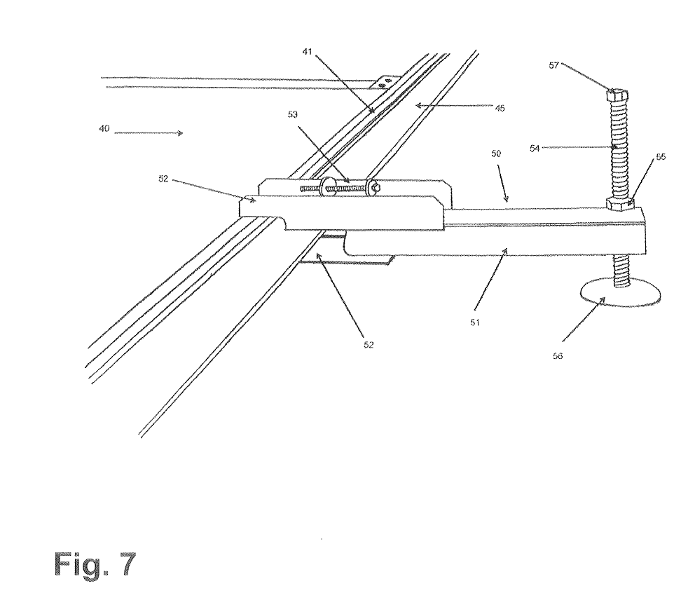

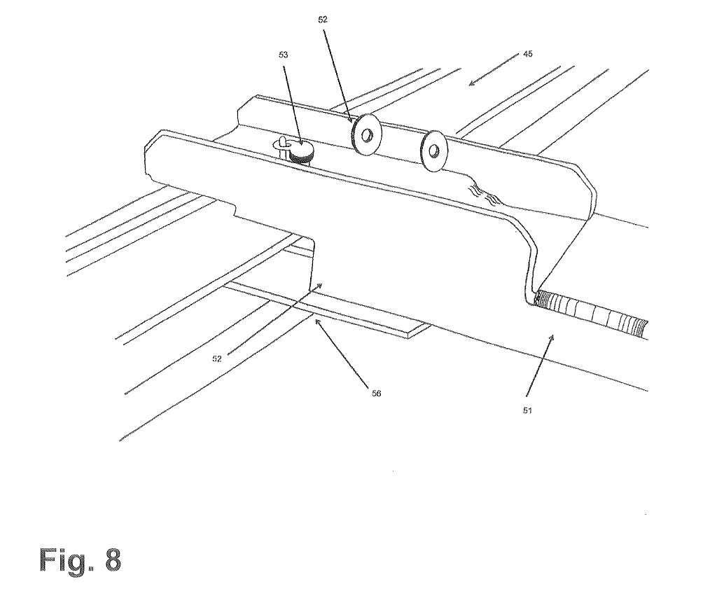

Referring to FIGS. 7 and 8, each of the stabilizers 50 has a support arm 51. The support arm 51 has at a first end a pair of jaws 52 defining a slot therebetween. Accordingly, the support arm 51 is connected to the trailer 14 by the flange 45 being received in the slot, whereby the support arm 51 projects laterally from the edge surface 41 of the platform 14. A pin 53 is provided in order to releasably lock the support arm 51 to the flange 45. More specifically, registered holes (not shown) are provided in the jaws 52, whereby the pin 53 is threaded into the holes in the jaws 52 and a corresponding hole in the flange 45. Eyelets are provided on the support arm 51 to support the pin 53 when not being used.

An adjustment mechanism is provided at the second end of the support arm 51 so as to adjust the vertical position of the stabilizer 50. In the illustrated embodiment, the adjustment mechanism comprises a threaded rod 54, threadingly engaged in a nut 55 at the second end of the support arm 51. A bottom end of the rod 54 has a base plate 56 having a diameter substantially larger than that of the rod 54. The base plate 56 is provided to contact the ground. A hexagonal head 57 is provided at the other end of the rod 54, and is used to manually rotate the rod 54 (e.g., with a wrench) so as to adjust a vertical position of the base plate 56. It is observed that the embodiment of FIG. 7 has a longitudinal axis of the rod 54 normal with respect to a plane of the support surface 40.

The combination of the threaded rod 54 and nut 55 is advantageously self-locking along the longitudinal axis of the rod 54. Therefore, once the base plate 56 contacts the ground, there is no need to lock the threaded rod 54 at the position. It is nonetheless considered to use other types of adjustment mechanisms, such as lockable pivots or parallelograms, to vary the vertical position of the base plate 56 with respect to the platform 14.

It is pointed out that the platform 14 may not necessarily have a flange 45. In such a case, other connection means (e.g., bolts projecting from the platform 14) are considered to connect the stabilizers 50 to the platform 14.

In order to install any one of the stabilizers 50 to the platform 14, the jaws 52 accommodate the flange 45 in their slot. The support arm 51 is displaced along the flange 45 until the holes in the jaws 52 are aligned with the hole in the flange 45, whereby the pin 53 is threaded into the holes to releasably lock the support arm 51 to the flange 45. The rod 54 is then rotated until the base plate 56 firmly contacts the ground, thereby increasing the footing of the platform 14.

As a safety measure, the holes in the flange 45 are provided at the corners of the platform 14, such that the operator installing the stabilizers 50 is not next to the load (i.e., the concrete panels C) during installation. Stabilizers 50 are preferably installed at the four corners of the platform 14.

Referring to FIG. 6, the rack 43 is configured to support the stabilizers 50 when not being used.

1. A trailer and platform unit of the type having a trailer defining a rear-end opening from the ground up through which an enclosure is accessed, with the platform adapted to support material and being loaded onto the trailer through the rear-end opening by the trailer backing into the platform whereby the platform engages and is supported by rails on opposed sides of the enclosure, the platform comprising:
a support surface adapted to support material and lateral edge surfaces defining a periphery of the platform; and
at least one stabilizer device having a support arm with a first end connected to the platform, a second end projecting laterally away from one of the lateral edge surfaces of the platform, a base plate at the second end of the support arm, and an adjustment mechanism to set the vertical position of the base plate with respect to the platform so as to increase the footing of the platform on the ground.

2. The trailer and platform unit according to claim 1, wherein the adjustment mechanism has a threaded rod threadingly engaged to the second end of the support arm, the base plate being connected to a bottom end of the threaded rod, whereby the threaded rod is rotated to adjust the vertical position of the base plate.

3. The trailer and platform unit according to claim 2, wherein a longitudinal axis of the threaded rod is generally normal to a plane of the support surface of the platform.

4. The trailer and platform unit according to claim 1, wherein the first end of the support arm has a slot between jaws accommodating a flange of the lateral edge surface of the platform.

5. The trailer and platform unit according to claim 4, wherein the stabilizer device is releasably secured to the platform by a pin threaded through registered holes in the jaws of the first end and a hole in the flange of the lateral edge surface.

6. The trailer and platform unit according to claim 1, further comprising four of the stabilizer devices, with each one of the stabilizer devices being positioned adjacent to a respective corner of the platform.

7. A trailer and platform unit of the type having a rear end of the trailer separated into left and right side portions, with an enclosure being defined from the ground up between the side portions, the enclosure being accessed through a rear-end opening of the trailer, with the platform being adapted to support material and being loaded onto the trailer through the rear-end opening by the trailer backing into the platform whereby the platform engages and is supported by rails within the enclosure and on each of the side portions, the trailer having a width-adjustment mechanism comprising:
an actuator adjacent to the rear-end opening in one of the side portions, the actuator having an actuator arm displaceable along a width of the trailer as a function of actuation of the actuator; and
a connection bar releasably connected at a first end to the actuator arm and at a second end to the other one of the side portions;
whereby the actuator is actuated to adjust a width between the rails of the side portions of the trailer as a function of the width of the platform to be supported by the rails.

8. The trailer and platform unit according to claim 7, wherein the actuator has a set position for the actuator arm, the set position corresponding to the width of the platform.

9. The trailer and platform unit according to claim 7, further comprising a fixing bar releasably connected at opposed ends to the right and left side portions so as to keep the side portions separated by the adjusted width when the trailer is loaded.

10. The trailer and platform unit according to claim 9, wherein the fixing bar is connected to the rails.

11. The trailer and platform unit according to claim 7, wherein the actuator is provided with a lever for manual actuation.

12. The trailer and platform unit according to claim 7, wherein the actuator is accommodated within one of the side portions.

13. The trailer and platform unit according to claim 7, wherein a built-in pivot is provided in the other one of the side portions so as to support the second end of the connection bar.

14. A trailer and platform unit of the type having a rear end of the trailer separated into left and right side portions, with an enclosure being defined from the ground up between the side portions, the enclosure being accessed through a rear-end opening of the trailer, with the platform being adapted to support material and being loaded onto the trailer through the rear-end opening by the trailer backing into the platform whereby the platform engages and is supported by rails within the enclosure and on each of the side portions, the trailer comprising a first wheel system on the left side portion of the trailer, and a second wheel system on the right side portion of the trailer, each of the wheel systems having wheels supporting the trailer to the ground, and a height-adjustment mechanism so as to adjust a height of the trailer with respect to the ground, the height-adjustment mechanisms of the first and second wheel systems being independent from one another so as to independently adjust the heights of the left side portion and of the right side portion of the trailer, whereby a plane of the rails is leveled with the platform by actuation of at least one of the height-adjustment mechanisms prior to loading the platform on the trailer.

15. The trailer and platform unit according to claim 14, wherein the height-adjustment mechanisms each comprise at least one conduit interconnecting an air spring of the wheel systems to a pressure source, and at least one valve in each said conduit to selectively provide pressure to the air springs.
